(19) United States
(12) Patent Application Publication
(10) Pub. No.: US 2017/0010793 A1
(43) Pub. Date: Jan. 12, 2017

(54) INFORMATION-PROCESSING DEVICE, INFORMATION DISPLAY METHOD, AND RECORDING MEDIUM

(71) Applicant: NEC CORPORATION, Minato-ku, Tokyo (JP)

(72) Inventor: Hidenaga MATSUSHIMA, Tokyo (JP)

(73) Assignee: NEC Corporation, MInato-ku, Tokyo (JP)

(21) Appl. No.: 15/119,531

(22) PCT Filed: Feb. 24, 2015
(86) PCT No.: PCT/JP2015/000889

§ 371 Date: Aug. 17, 2016

(30) Foreign Application Priority Data
Feb. 28, 2014 (JP) 2014-037799

(51) Int. Cl. G06F 3/0484; G06F 7/08

(52) U.S. Cl. CPC G06F 3/04845; G06F 7/08

(57) ABSTRACT

This invention provides a user-interface technology that improves operability of information. An information-processing device (100) has an operation detection unit (101), a determination unit (102), and a drawing processing unit (103). The operation detection unit (101) detects predetermined operations performed on cards located in an input area that allows input to information on cards. The input area and a subsequent area are arranged in a predetermined direction in a display area. When the operation detection unit (101) detects a predetermined operation, on the basis of the state of the information on a card located in the input area, the determination unit (102) determines a sorting area as a move destination of the card, from among a plurality of sorting areas provided in the subsequent area. The drawing processing unit (103) moves the card located in the input area to the determined sorting area.

### TECHNICAL FIELD

The present invention relates to an information processing technology for individually displaying pieces of information to be processed.

### BACKGROUND ART

Smart devices such as a smartphone, a tablet terminal and the like are utilized in business use in addition to private use. Applications, which run on the smart devices, employ, however, the same GUIs (Graphical User Interfaces) as used for stationary PCs (Personal Computers) such as tabs and a tree view.

Such existing GUIs are designed for operations based on a movement on an input device such as a mouse, a keyboard or the like (hereinafter denoted as equipment operations). Such operations are conducted while looking at a display unit having a large display region. Accordingly, existing GUIs are not suitable for operations based on a movement of user's body or body part itself, such as touching, gesturing or the like (hereinafter denoted as body operations) which is conducted on a narrow display region. It is easy for user to guess an operating method by use of body operations. On the other hand, it has difficulty to adapt body operations for precise movements as compared with equipment operation.

In PTL 1 cited below, a method of improving operability of a scroll bar, which is an existing GUI component, is provided. The method provided therein includes determining whether or not a position on a screen indicated by a user is on a scroll bar or on a predetermined region around the scroll bar and expanding the width of the scroll bar according to the determined result.

### CITATION LIST

### Patent Literature

[PTL 1] Japanese Laid-open Patent Publication No. 2004-192573

### SUMMARY OF INVENTION

### Technical Problem

The proposed method described above facilitates scrolling operations. However, the method does not improve the operability of basic operations, such as selecting a desired piece of information from a large amount of information displayed in such forms as a tab display, a list display, a tree view and the like, and editing the selected piece of information.

In general, smart devices have a narrow display region and, these devices are mainly operated by body operations. Further, smart devices in business use are more likely to be used outside company offices. This is because in company offices conventional desktop PCs can be generally used. Further, smart devices are likely to be used not on a desk but elsewhere because of their high portability. When an existing GUI is employed for the smart device, the space for performing operations for accessing desired information is limited. Therefore, it is difficult to perform basic operations as described above.

The present invention has been made in consideration of these circumstances and is to provide a user interface technology that improves operability of information. A user interface technology provided by the present invention is not only effective in computers that are called smart devices but widely effective for information processing apparatuses in general.

### Solution to Problem

Aspects of the present invention respectively adopt the following configurations in order to solve the above-described problem.

The first aspect of the present invention relates to an information processing apparatus allowing a display unit to display a piece of information as a processing target in a card format. The information processing apparatus according to the first aspect of the present invention includes:

an operation detection means, when an input area and a subsequent area are arranged in a predetermined direction in a display area displayed on a display unit, for detecting a predetermined operation for a card placed in the input area, the card being able to indicate a piece of information as a processing target in a card format, the input area allowing input to the piece of information that is indicated by the card,

a determination means, when the operation detection means detects the predetermined operation, on the basis of a state of the piece of information indicated by the card placed in the input area, for determining a sorting area as a move destination of the card from among a plurality of sorting areas provided in the subsequent area, and

a drawing processing means for moving the card placed in the input area to the sorting area determined by the determination unit as the move destination.

The second aspect of the present invention relates to an information displaying method executed by at least one computer allowing a display unit to display a piece of information as a processing target in a card format. The information displaying method according to the second aspect of the present invention includes:

when an input area and a subsequent area are arranged in a predetermined direction in a display area displayed in a display unit, detecting a predetermined operation for a card placed in the input area, the card being able to indicate a piece of information as a processing target in a card format, the input area allowing input to the piece of information that is indicated by the card,

when the predetermined operation is detected, on the basis of a state of the piece of information indicated by the card placed in the input area, determining a sorting area as a move destination of the card from among a plurality of sorting areas provided in the subsequent area,

moving the card placed in the input area to the sorting area determined as the move destination, and

controlling the display unit to display the display area and the card.

A further aspect of the present invention may be related to a program that causes at least one computer to execute the above method according to the second aspect. Additionally, a further aspect of the present invention may be related to a computer-readable recording medium storing such a program. The recording medium includes a non-transitory tangible medium.

### Advantageous Effects of Invention

According to each of the above aspects, a user interface technology can be provided which improves operability of information.

### BRIEF DESCRIPTION OF DRAWINGS

FIG. 1 is a diagram schematically showing an example of processing configuration of an information processing apparatus according to an exemplary embodiment of the present invention.

FIG. 2 is a flow chart showing an operation example of the information processing apparatus according to the exemplary embodiment of the present invention.

FIG. 3 is a diagram schematically showing an example of information display according to the exemplary embodiment of the present invention.

FIG. 4 is a diagram schematically showing a hardware configuration example of a smart device according to a first exemplary embodiment of the present invention.

FIG. 5 is a diagram schematically showing an example of processing configuration of the smart device according to the first exemplary embodiment of the present invention.

FIG. 6 is a flow chart showing an operation example of the smart device according to the first exemplary embodiment of the present invention.

FIG. 7 is a diagram schematically showing an example of information display according to the first exemplary embodiment of the present invention.

FIG. 8 is a diagram schematically showing an example of processing configuration of a smart device according to a second exemplary embodiment of the present invention.

FIG. 9 is a flow chart showing a part of an operation example of the smart device according to the second exemplary embodiment of the present invention.

FIG. 10 is a diagram schematically showing a first example of information display according to the second exemplary embodiment of the present invention.

FIG. 11 is a diagram schematically showing a second example of information display according to the second exemplary embodiment.

### DESCRIPTION OF EMBODIMENTS

In the following, exemplary embodiments according to the present invention will be described. The exemplary embodiments described below are for illustrative purposes only and the present invention is not limited to the configurations of the following exemplary embodiments.

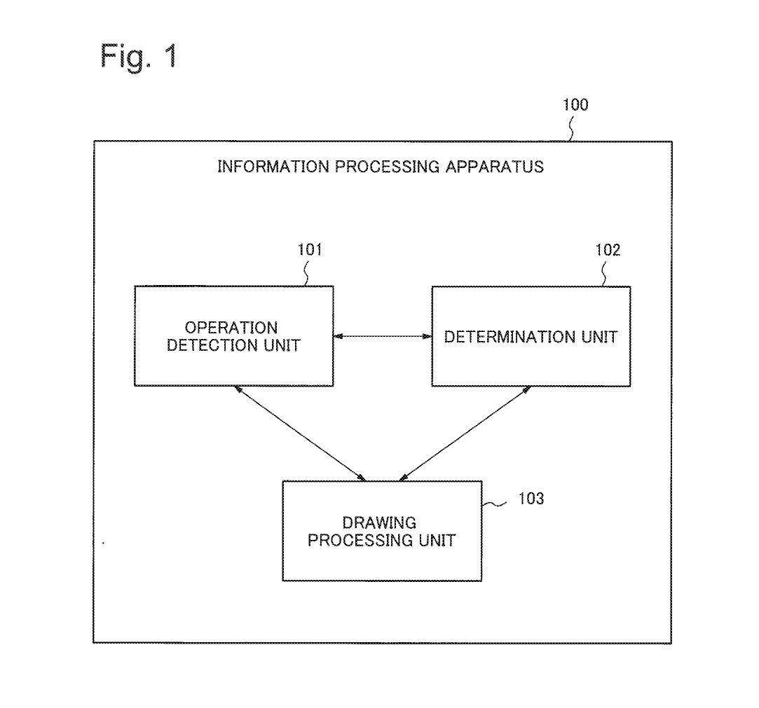

FIG. 1 is a diagram schematically showing an example of processing configuration of an information processing apparatus in the present exemplary embodiment. As shown in FIG. 1, the information processing apparatus 100 causes a display unit to display pieces of information to be processed, in a card format. The information processing apparatus 100 includes an operation detection unit 101, a determination unit 102, and a drawing processing unit 103. The operation detection unit 101 detects the predetermined operation on a card placed in an input area among the input area and a subsequent area being arranged in a predetermined direction in a display area. In the input area, input to a piece of information indicated by the card is allowed. When the operation detection unit 101 detects a predetermined operation, the determination unit 102 determines a sorting area that serves as a destination to which the card is to be moved, among a plurality of sorting areas provided in the subsequent area, on the basis of a state of the piece of information indicated by the card placed in the input area. The drawing processing unit 103 moves the card placed in the input area to the sorting area that was determined by the determination unit 102 to be the move destination.

The information processing apparatus 100 shown in FIG. 1 includes the same hardware configuration as, for example, that of smart devices (10A, 10B) in detailed exemplary embodiments, which will be described later. Each configuration unit described above may be realized by processing a program in the same manner as in the smart devices (10A, 10B). Additionally, the above display unit may be included in the information processing apparatus 100 or included in another computer (not shown) communicably connected to the information processing apparatus 100. Such a display unit is an apparatus that displays a screen corresponding to drawing data, such as an LCD (Liquid Crystal Display), a CRT (Cathode Ray Tube) display, or the like.

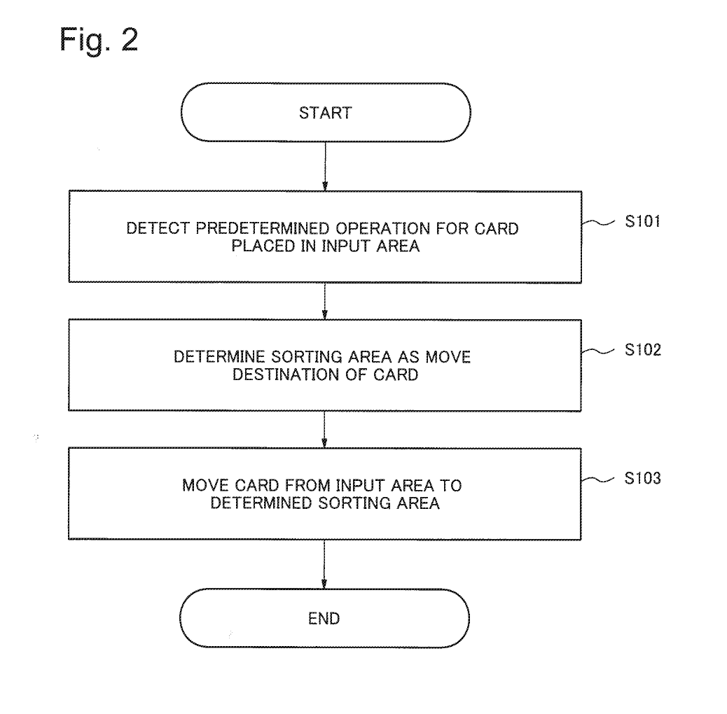

Next, an information display method in the present exemplary embodiment will be described with reference to FIG. 2. FIG. 2 is a flow chart showing an example of operation of the information processing apparatus 100 according to the present exemplary embodiment. As shown in FIG. 2, the information display method according to the present exemplary embodiment is executed by at least one computer such as the information processing apparatus 100. The information display method according to the present exemplary embodiment causes the display unit to display pieces of information to be processed in a card format. The above display unit may be included in a computer that executes the information display method or may be included in another computer (not shown).

The information display method according to the present exemplary embodiment includes the following processing (steps). That is, the information display method includes detecting a predetermined operation on a card placed in an input area allowing input to a piece of information indicated by the card, among the input area and a subsequent area being arranged in a predetermined direction in a display area (S101). The information display method includes determining, when the predetermined operation is detected, a sorting area that serves as a destination to which to move the card, among a plurality of sorting areas provided in the subsequent area, on the basis of a state of the piece of information indicated by the card placed in the input area (S102). The information display method includes moving the card placed in the input area to the sorting area that was determined by the determination unit 102 to be the move destination (S103).

The order of execution of the above respective steps is not limited to the order shown in FIG. 2. Additionally, exemplary embodiments of the present invention may be related to a program, which causes a computer to execute the above-described information display method, or may be related to a computer-readable recording medium storing such a program.

In the present exemplary embodiment, each piece of information to be processed is displayed in a card format (single-sheet format). The description “display in a card format” denotes displaying a piece of information so that the piece of information can be recognized and operated individually, in a drawn element being formed into any shape.

In other words, the term “card” is used for convenience of explanation, and the term in itself represents no particular intention to limit a form. A shape of the drawn element in which information is to be displayed is not particularly limited and may be two-dimensional shape or three-dimensional shape. The shape may adopt a sheet-shape or any other shape, for example, a bubble. Contents of information to be processed are also not limited. A unit of information that is indicated by the card (a unit of information displayed in the card format) is not limited, either. Information indicated by a plurality of cards may overlap with each other. However, when information units displayed as a card correspond to work units of a user, operability for the user may further be improved. Herein, an individual piece of “information” denotes a piece of information indicated (specified) by one card.

In the present exemplary embodiment, the input area and the subsequent area are arranged in a predetermined direction in the display area, and a plurality of sorting areas are placed in the subsequent area. The display area represents an entire or a part of a display region in the display unit, and the input area represents a region in which input to information indicated by the card is allowed. The input area and the subsequent area indicate certain ranges within the display area. Boundaries of the input area and subsequent area may be overlapped with each other or may be spaced apart from each other. For example, the input area and the subsequent area are arranged in a horizontal, vertical, or oblique direction.

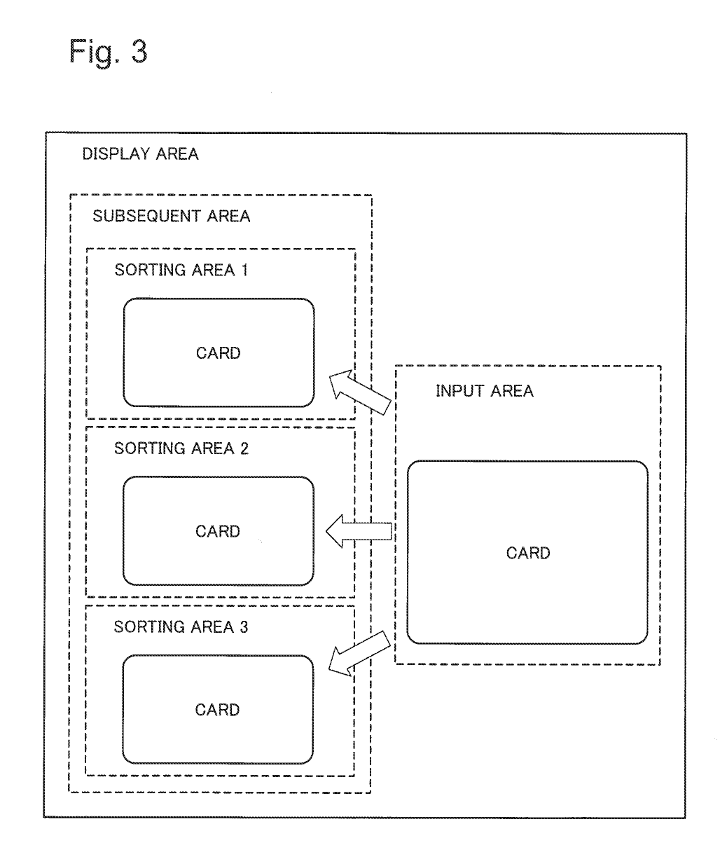

FIG. 3 is a diagram schematically showing an example of information display in the exemplary embodiment. In the example in FIG. 3, each card has a shape of a rectangle with rounded corners. The input area is placed on the right and the subsequent area is placed on the left. The subsequent area includes with three sorting areas.

In the present exemplary embodiment, as shown in FIG. 3, a predetermined operation for the card placed in the input area is detected, and the card is moved from the input area to one of the sorting areas in the subsequent area. The sorting area to which the card is moved is determined on the basis of a state of the information indicated by the card. States of information indicated by the card can include a result of a determination based on content of information, such as being normal or abnormal, or a success or failure. For example, states of information indicated by the card may include a status of work, for example, being completed or uncompleted. For example, states of information indicated by the card may also include classification and the like of information, such as classification according to persons in charge of inputting, or classification based on information categories. The number of sorting areas placed in the subsequent area is determined on the basis of a sorting rule. The predetermined operation to be detected is an operation upon which the card is moved from the input area to the subsequent area. Therefore, for example, an operation indicating a break of work (completion, suspension, etc.) with regard to the piece of information indicated by the card is assigned as a predetermined operation to be detected. A predetermined operation may be a pressing of a displayed button, a predetermined gesture, or a predetermined voice operation.

Thus, according to the present exemplary embodiment, by checking to which sorting area a card has been moved, a user can visually understand a state of the piece of information indicated by the card with ease. Further, according to the present exemplary embodiment, by displaying information in a card format, a space for conducting operations for accessing desired information is enlarged. As a result, according to the present exemplary embodiment, for example, the user can execute an operation of adding input to a piece of information more easily, as compared with a list display, a tree view display, and the like. That is, the present exemplary embodiment facilitates operations for information referencing and information input even with a smart device having a narrow display area and being mainly operated by body operations.

In the present exemplary embodiment, the drawing processing unit 103 can move a card placed in the input area to the sorting area, and place a new card indicating another piece of information in the input area. Similarly, the information display method in the present exemplary embodiment may further include, after the processing at S103 or simultaneously with the processing at S103, arranging the new card indicating another piece of information in the input area. According to this, a subsequent new card can be placed in the input area when a user executes the predetermined operation for the card placed in the input area. As a result, the user can easily find a piece of information to be accessed next without fail.

In the following, the above-described exemplary embodiment will be described in further detail. In the following, as a detailed exemplary embodiment, a smart device will be illustrated. Contents of the above-described exemplary embodiment and each of detailed exemplary embodiments (a first exemplary embodiment and a second exemplary embodiment) that will be described later are applicable not only to a smart device but also to any computer capable of executing an application having a GUI. In the following, a first exemplary embodiment and a second exemplary embodiment as the detailed exemplary embodiments will be described mainly with respect to the configurations different from the above-described configurations, and with respect to the same configurations, description thereof will be appropriately omitted.

### First Exemplary Embodiment

### Hardware Configuration

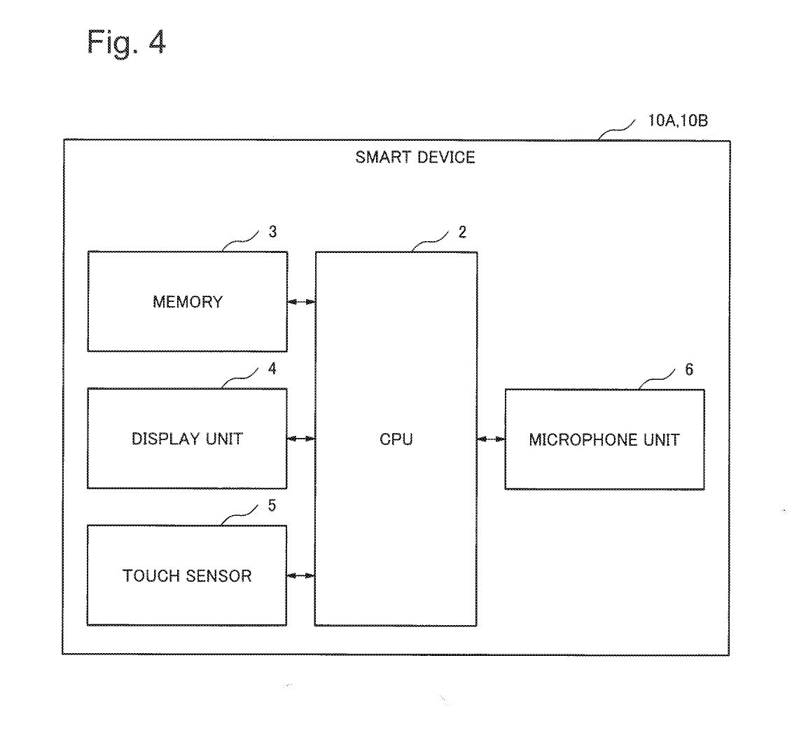

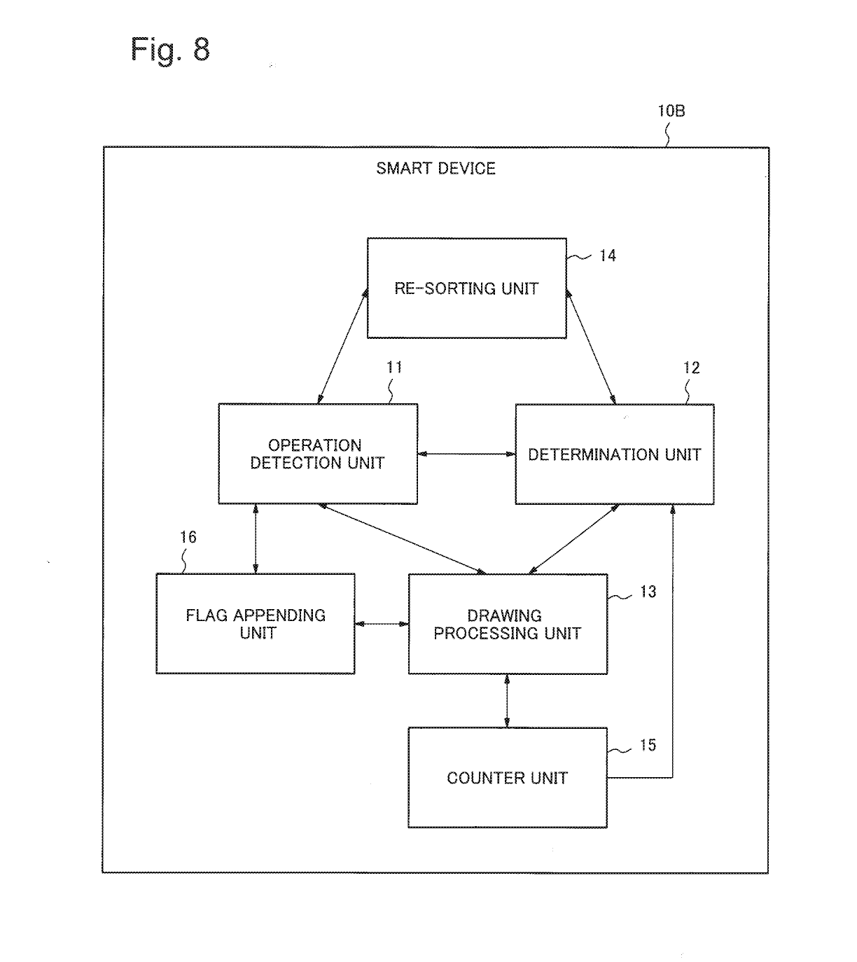

FIG. 4 is a diagram schematically showing a hardware configuration example of a smart device 10A in a first exemplary embodiment. The smart device 10A in the first exemplary embodiment includes a CPU (Central Processing Unit) 2, a memory 3, a display unit 4, a touch sensor 5, a microphone unit 6 and other components. The hardware configuration of the smart device 10A in the first exemplary embodiment is not limited to the example shown in FIG. 4. A smart device 10B (FIG. 8) in a second exemplary embodiment to be described later also can be realized by the same hardware configuration as that shown in FIG. 4. In the following example, a hardware configuration will be described with the smart device 10A in the first exemplary embodiment as a specific example. The following description will also apply to the smart device 10B according to the second exemplary embodiment.

The CPU 2 is connected to each of the other units by a communication line such as a bus. The memory 3 is a Random Access Memory (RAM), a Read Only Memory (ROM), or a subsidiary storage apparatus (a hard disk etc.). The display unit 4 includes a monitor such as Liquid Crystal Display (LCD) or a Cathode Ray Tube (CRT) display and executes display processing.

The touch sensor 5 accepts an operation input by a user by sensing a contact by the outside object. The touch sensor 5 may be a sensor capable of sensing an approaching state of the outside object, in a non-contact state. The display unit 4 and the touch sensor 5 may be realized as a touch panel unit. Further, the smart device 10A may be configured to include an imaging unit (not shown) for recognizing a gesture or the like, together with the touch sensor 5 or in place of the touch sensor 5.

The microphone unit 6 is a sound collecting apparatus. In the example of FIG. 4, as a hardware element capable of detecting a user operation, the touch sensor 5 and the microphone unit 6 are illustrated. As a hardware element capable of detecting a user operation, the smart devices 10A and 10B may include, other than those described above, a vibration sensor, an acceleration sensor, a geomagnetic sensor (these not shown) capable of detecting other types of user operations.

<Processing Configuration>

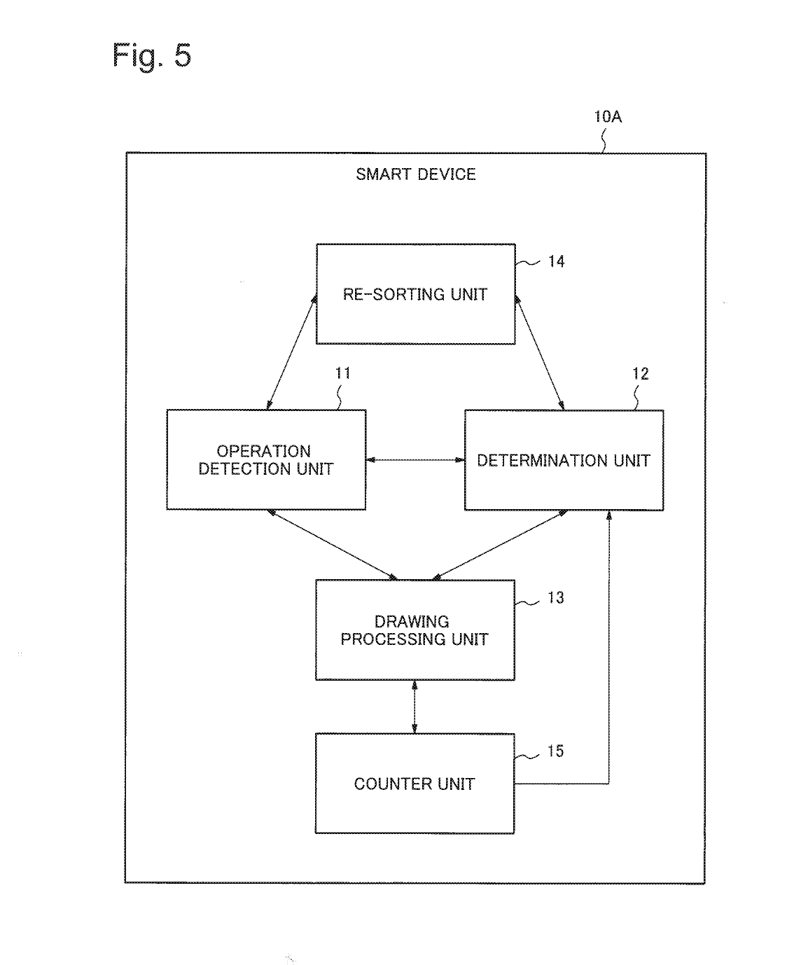

FIG. 5 is a diagram schematically showing an example of processing configuration of the smart device 10A in the first exemplary embodiment. The smart device 10A in the first exemplary embodiment includes an operation detection unit 11, a determination unit 12, a drawing processing unit 13, a re-sorting unit 14, a counter unit 15 and the like. These respective processing units are realized by, for example, executing a program stored in the memory 3 by the CPU 2. Additionally, the program may be installed from, for example, a portable recording medium such as a memory card, or another computer on a network through an input/output interface (I/F) or a communication unit (both not shown), and be stored in the memory 3.

The operation detection unit 11 corresponds to the above-described operation detection unit 101. The operation detection unit 11 detects certain user operations on the basis of information from the touch sensor 5, the microphone unit 6 and the like. Specific user operations being detected by the operation detection unit 11 include the above-described predetermined operations, i.e., operations that trigger to move a card from the input area to the subsequent area (hereinafter referred to as closing operations). The particular user operations further include operations indicating switching of sorting (hereinafter denoted to as switching operations) and operations indicating a move of the sorting area (hereinafter denoted to as re-waiting operations).

The determination unit 12 corresponds to the above-described determination unit 102. On the basis of a state of a piece of information indicated by a card placed in the input area, and the determination rule for the sorting area described above, the determination unit 12 determines the sorting area as a move destination of the card from among the plurality of sorting areas included in the subsequent area. In the determination rule for the sorting area, a correspondence relationship is defined between conditions for information states and the sorting areas. The sorting area may also be identified by a sorting area identifier (ID, identification information). With respect to each determination rule, the determination unit 12 stores a rule ID, and the correspondence relationship between states of information and the sorting areas. There is no limitation on the number and the contents of such determination rules for the sorting area.

The determination rules for the sorting area can be changed by the re-sorting unit 14 that will be described later. When the determination rule is changed by the re-sorting unit 14, the determination unit 12 determines a sorting area as a move destination of a card placed in the input area on the basis of the changed determination rule.

Additionally, the determination unit 12 specifies a plurality of pieces of uncompleted information from among pieces of information indicated in the card format. In this case, the determination unit 12 may specify a plurality of pieces of uncompleted information from among all pieces of information indicated in the card format. Information to be indicated in the card format may be stored in advance by the smart device 10A or may be obtained from another computer. A “piece of uncompleted information” denotes a piece of information on which an input task (input processing) is not completed yet. Additionally, a piece of information of which the input task is suspended may also be regarded as the piece of uncompleted information.

The determination unit 12 can determine whether a piece of information to be processed is in an uncompleted state or not, by checking whether a completion flag or a non-completion flag is appended to the piece of information. By checking whether content to be supplied, in the piece of information to be processed remains or not, the determination unit 12 can determine whether the piece of information is uncompleted or not. When the uncompleted state includes a suspended state, for example, a suspension flag may be appended to the information. In this case, the determination unit 12 can determine whether a piece of information is uncompleted or not by checking for a suspension flag.

The counter unit 15 obtains the total number of pieces of information displayed by the card format, the number of pieces of uncompleted information specified by the determination unit 12, and the number of pieces of information indicated by cards placed in each sorting area. In other words, the counter unit 15 obtains the total number of cards, the number of cards placed in a waiting area (that will be described later), and the number of cards placed in each sorting area. A method of specifying uncompleted information is the same as that of the determination unit 12. The number of cards placed in each sorting area may be counted on the basis of a move of a card from the input area to the sorting area by the drawing processing unit 13. Additionally, an ID of a sorting area in which the piece of information is placed, is assigned to each piece of information, and the number of cards placed in each sorting area may be counted on the basis of the IDs.

The re-sorting unit 14 changes a determination rule for the sorting area. The re-sorting unit 14 reconfigures the sorting areas arranged in the subsequent area, and rearranges the cards already placed in the sorting areas into each of the reconfigured sorting areas, on the basis of the changed determination rule. In the reconfiguration of sorting areas, the meanings respectively assigned to the sorting areas are changed. In some cases, the number of sorting areas may be changed before and after the change, in accordance with determination rules. For example, during a reconfiguration of sorting areas, two sorting areas that respectively indicate the normal state and abnormal state, are converted into four sorting areas that indicate four classifications related to the contents of information, such as content classifications A, B, C and D. In the rearrangement of cards, a plurality of cards placed in the respective sorting areas before the change are rearranged in the respective reconfigured sorting areas on the basis of the changed determination rule.

When the operation detection unit 11 detects an operation indicating switching of sorting (a switching operation), the re-sorting unit 14 is executed. This switching operation may be a pressing of a displayed button, a predetermined gesture, a predetermined voice-activated operation, or the like.

The drawing processing unit 13 corresponds to the above-described drawing processing unit 103. The drawing processing unit 13 according to the present exemplary embodiment handles a waiting area, which is included in the display area, in addition to the input area and the subsequent area. The waiting area is arranged at opposite side to the subsequent area so as to be placed in a predetermined direction in the display area, by the input area lying therebetween. Directions in which the waiting area, the input area, and the subsequent area may be arranged are not limited. The drawing processing unit 13 executes processing of displaying a plurality of cards each indicating each piece of uncompleted information that has been specified by the determination unit 12, in a stacked form in the waiting area. In this case, for example, the drawing processing unit 13 may control the display unit 4 to perform the display processing. Similarly, the drawing processing unit 13 may execute processing of displaying the cards placed in the respective plurality of sorting areas in a stacked form. Displaying by the drawing processing unit 13 denotes processing executed by the drawing processing unit 13 to cause the display unit 4 to display a desired image (a card or the like). Processing related to display executed by the drawing processing unit 13 may include processing of controlling the display unit 4 so as to draw a desired image (a card or the like). Additionally, displaying in a stacked form denotes showing a plurality of cards to the user so that cards are stacked. Methods for realizing the displaying method are not specifically limited. As an example, the drawing processing unit 13 can in advance store images respectively indicating stacked cards for each number of layers and switching these images. The drawing processing unit 13 may cause the display unit 4 to display cards of the exactly same number as the number of card being included in a stack. The drawing processing unit 13 may also cause the display unit 4 to display a sufficient number of cards in a stack to indicate whether there is more than one card.

The drawing processing unit 13 moves a card on the uppermost layer of the card stack in the waiting area to the input area as a new card, when drawing processing unit 13 moves a card placed in the input area to a sorting area in the subsequent area. The card on the uppermost layer of the card stack is, for example, a card placed at the top of the cards displayed in a stacked form (stacked cards).

When executing the processing of displaying a plurality of cards in the stacked form, the drawing processing unit 13 can determine a card to be located on the uppermost layer, and display the piece of information indicated by the card when the card is displayed on the uppermost layer. In this case, the drawing processing unit 13 may execute processing of displaying, on the card on the uppermost layer, a part or whole of the information of the card. Additionally, the drawing processing unit 13 may execute processing of displaying, on the card on the uppermost layer, a summary of the information of the card or an image picture of the information. The drawing processing unit 13 can also execute processing of displaying, on a card on a layer lower than the uppermost layer, part of information of each card when possible.

A sequence number may be attached in advance to each piece of information indicated in the card format. In this case, on the basis of the sequence number, the drawing processing unit 13 can determine the cards on the uppermost layer of each card stack in the waiting area and the sorting areas. The sequence number may be attached only to each piece of uncompleted information that is specified by the determination unit 12. This enables a user to understand information to be worked on next by referring to the card on the uppermost layer of the card stack in the waiting area.

On the basis of a total number of pieces of information obtained by the counter unit 15, the number of pieces of uncompleted information, and the number of pieces of information indicated by cards placed in each sorting area, the drawing processing unit 13 executes processing of displaying the total number and the number of pieces of uncompleted information in the waiting area. Additionally, the drawing processing unit 13 executes processing of displaying, in the subsequent area, the total number and the number in each sorting area. These numbers may be displayed on a card on the uppermost layer of a card stack in each area.

When the operation detection unit 11 detects an operation (re-waiting operation) that indicates a move of the sorting area, the drawing processing unit 13 moves a card placed in one of the plurality of sorting areas to the waiting area. The re-waiting operation includes an operation of selecting a sorting area to be moved and operation of instructing that the sorting area should be moved to the waiting area.

<Operation Example>

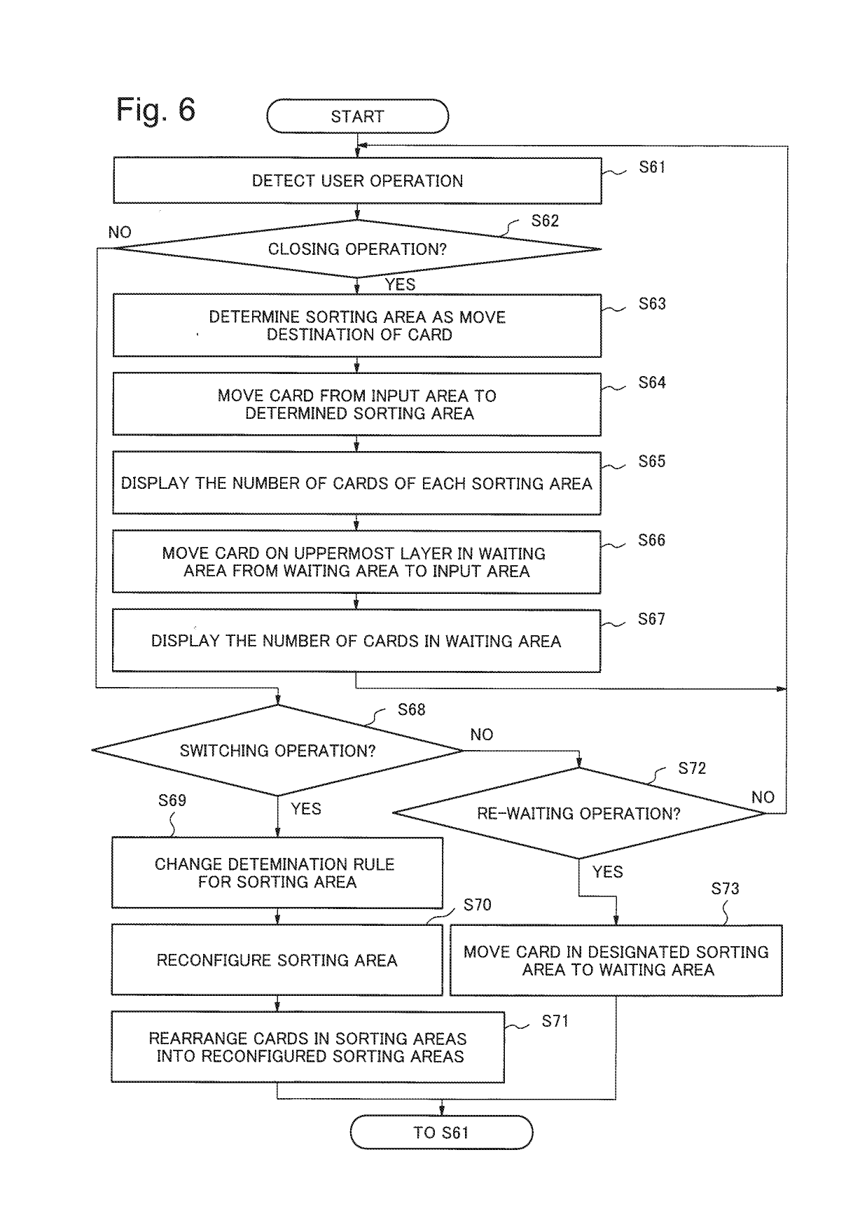

In the following, the information display method in the first exemplary embodiment will be explained with reference to FIG. 6. FIG. 6 is a flow chart showing an operation example of the smart device 10A in the first exemplary embodiment. Although in the following description, it is assumed that each step is executed by the smart device 10A, each step may be executed by a plurality of computers including the smart device 10A. Additionally, since processing of each step is similar to processing contents of the above-described respective processing units included in the smart device 10A, detailed description of each step will be omitted suitably.

The smart device 10A detects a user operation (S61). User operations to be detected include various kinds of operations detected by a common smart device 10A, such as a touch operation, a gesture operation, a voice-activated operation and the like.

When a closing operation is detected (S62; YES), the smart device 10A determines the sorting area as a move destination of a card placed in the input area (S63). Subsequently, the smart device 10A moves the card from the input area to the sorting area determined by the processing at S63 (S64).

When a plurality of cards is placed in the sorting area, the smart device 10A displays the cards in the sorting in a stacked form. Further, the smart device 10A obtains the number of cards of each sorting area and displays the obtained numbers in the subsequent area (S65). Having obtained the total number of cards, the smart device 10A can display the total number as well as the number of cards of each sorting area.

Further, the smart device 10A moves the card on the uppermost layer of the card stack in the waiting area to the input area (S66). As a result, a new card is placed in the input area and the number of cards in the waiting area is reduced. The smart device 10A obtains the number of cards in the waiting area and displays the obtained number in the waiting area (S67). The smart device 10A can also display the number of cards in the waiting area and the total number of cards.

On the other hand, when a switching operation is detected (S62; NO, S68; YES), the smart device 10A changes a determination rule for the sorting area (S69). The determination rule to be applied after the change is specified along with the switching operation. When executing the processing of S63 after the execution of the processing at S69, the smart device 10A uses the changed determination rule.

The smart device 10A reconfigures the sorting areas on the basis of the changed determination rule (S70). Further, the smart device 10A rearranges, for each sorting area reconfigured, the cards placed in the sorting areas before the reconfiguration (S71).

Additionally, when a re-waiting operation is detected (S62; NO, S68; NO, S72; YES), the smart device 10A moves a card in the designated sorting area, which is specified at the time of the re-waiting operation, to the waiting area (S73).

An order of execution of the above-described respective steps included in the information display method according to the first exemplary embodiment is not limited to the order shown in FIG. 6, and the order can be changed as long as the change does not affect the contents adversely. For example, the processing at S64 and the processing at S66 may be executed in parallel, and the processing at S65 and the processing at S67 may be executed in a reverse order. Additionally, the order of the processing related to determination of detected user operation (S62, S68 and S72) is also changeable.

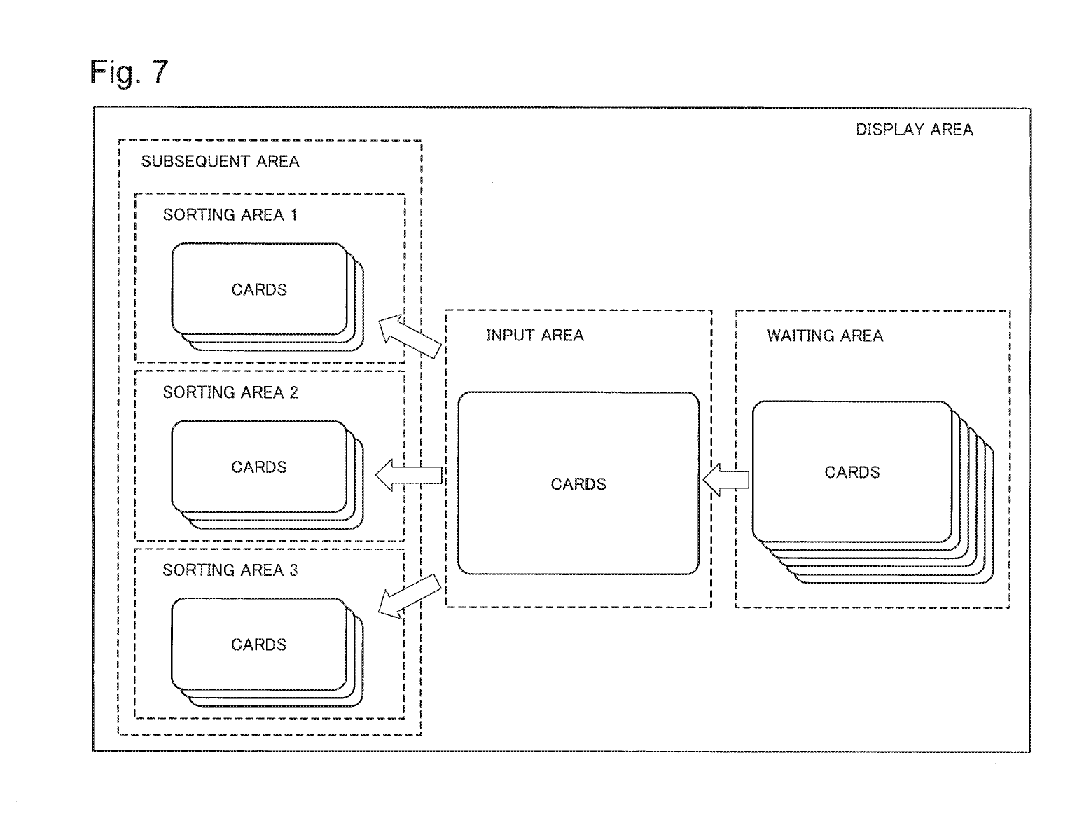

FIG. 7 is a diagram schematically showing an example of information display according to the first exemplary embodiment. In the example in FIG. 7, each card has a shape of a rectangle with rounded corners. The waiting area, the input area and the subsequent area are arranged from right to left in the display area. The subsequent area includes three sorting areas. Further, in the first exemplary embodiment, when a plurality of cards is placed in each area, the cards are displayed in a form of stacked cards.

<Functions and Effects of the First Exemplary Embodiment>

According to the first exemplary embodiment, as shown in FIG. 7, the waiting area, the input area and the subsequent area are arranged in a predetermined direction in the display area. In the waiting area, cards indicating a piece of uncompleted information are displayed in the stacked form of cards, and in each sorting area in the subsequent area, cards moved from the input area are displayed in the stacked form of cards. The card placed in the input area is then moved to the sorting area in the subsequent area and the card on the uppermost layer of the card stack in the waiting area is moved to the input area as a new card.

Thus, according to the first exemplary embodiment, by executing a closing operation for a card in the input area, a user can easily understand without a mistake a new piece of information (card) on which inputting work should be executed next. The user may execute the closing operation for the card in the input area, for example, when input work on the card in the input area is completed, or when the work is suspended to execute a subsequent work. Further, as described above, by checking to which sorting area a card is moved, the user can visually understand a state of the piece of information indicated by the card with ease. Additionally, since such function can be realized by the simple closing operation, which triggers to move the card from the input area, the function can be realized also by the smart device 10A, mainly operated by touch operation.

According to the first exemplary embodiment, since a card indicating a piece of uncompleted information, i.e., a card placed in the input area and waiting for input work, is displayed in the waiting area, the user can easily understand that information which is to be processed remains. Further, according to the first exemplary embodiment, since when a plurality of cards are placed in the waiting area or a sorting area, these cards are displayed as a stack, the user can estimate an approximate number of cards present in each area. Accordingly, when cards in the waiting area are displayed as a stack, the user can easily understand that a plurality of pieces of information to be processed still remains.

According to the first exemplary embodiment, it is possible to display, in the waiting area, the total number of pieces of information displayed in the card format and the number of pieces of uncompleted information. Is is also possible to display, in the subsequent area, the total number and the number of pieces of information indicated by cards placed in each sorting area. While it is difficult to indicate detailed numbers (a volume of work) by only displaying stacked cards, the display of numbers allow the user to understand easily a specific volume of remaining work, the number of pieces of information placed in each sorting area, and the like.

Further, according to the first exemplary embodiment, in response to the detection of a switching operation, determination rule for the sorting area is changed. Then, on the basis of the changed determination rule, reconfiguration of the sorting areas included in the subsequent area, and rearrangement of cards placed in the sorting area into each reconfigured sorting area are executed. Therefore, according to the first exemplary embodiment, the user can sequentially switch to a desired determination rule by setting a plurality of determination rules in advance. The user can thereby understand, from various points of view, a state of the piece of the information indicated by the card moved from the input area to the subsequent area.

Further, according to the first exemplary embodiment, in response to the detection of a re-waiting operation, a card in the sorting area is moved to the waiting area. This enables the user to place a card that indicates a piece of information in suspended state, a piece of information presenting something to care about, or the like, in the input area once again, and thereby changing the state of the card to a state allowing to execute an inputting work thereon.

### Second Exemplary Embodiment

The smart device 10B according to the second exemplary embodiment enables an information flag to be appended to a piece of information indicated by a card placed in the input area. In the following, the smart device 10B according to the second exemplary embodiment will be described mainly with respect to contents different from those of the first exemplary embodiment. In the following, description of the same contents as those of the first exemplary embodiment will be omitted suitably.

<Processing Configuration>

FIG. 8 is a diagram schematically showing an example of processing configuration of the smart device 10B according to the second exemplary embodiment. As shown in FIG. 8, the smart device 10B according to the second exemplary embodiment further includes a flag-appending unit 16 in addition to the configuration according to the first exemplary embodiment. The flag-appending unit 16 can be also realized in the same manner as the other processing units. More specifically, the flag-appending unit 16 can be realized using the hardware configuration of the smart device 10B illustrated in FIG. 4 similarly to the other processing units.

The flag-appending unit 16 appends an information flag to a piece of information indicated by a card placed in the input area. An information flag is represented by binary values indicating whether the flag is appended or not. An ID representing each kind of flags is assigned to a piece of information as the information flag, when a plurality of kinds of information flags is provided. An information flag may be, for example, a “care flag” to be appended to a piece of information to be cared about, a “favorite flag” to be appended to a favorite piece of information, a “reference flag” to be appended to a piece of information to be referred, a “suspension flag” or the like. In the present exemplary embodiment, there is no limitation on the contents of information flags.

The flag-appending unit 16 executes the above-described processing in response to detection by the operation detection unit 11 of an operation of appending a flag to a card placed in the input area. A flag appending operation, similarly to other predetermined operations, may be a predetermined touch operation, a pressing operation of a displayed button, a predetermined gesture operation, or a predetermined voice operation. When a plurality of kinds of flags is provided, different flag appending operations may be respectively assigned to different kinds of flags.

The drawing processing unit 13 changes a display format of a card indicating a piece of information to which the information flag is appended to a display format different from that of a card indicating a piece of information to which no information flag is appended. To change the display format, the drawing processing unit 13 can execute color changing, deformation, expansion and the like. For example, the drawing processing unit 13 can append a dog-ear (a folded corner), a tag or the like to a card indicating a piece of information to which the information flag appended. Additionally, when a plurality of kinds of information flags are provided, the drawing processing unit 13 can change the display format of a card indicating a piece of information to which the information flag appended, to a different display format in accordance with the kind of the flag. The user can thereby understand the kind of the information flag appended to the piece of information on the basis of a displaying format of the card.

Further, the drawing processing unit 13 can move a card indicating a piece of information with the information flag appended thereto from the input area to a sorting area. The drawing processing unit 13 can also execute processing of displaying the piece of information indicated by the card in a card format fixedly in a partial area being different from the waiting area, the input area, and the subsequent area.

The determination unit 12 can use a determination rule for the sorting area including a rule regarding the presence or absence of an information flag. Specifically, the determination unit 12 determines whether the piece of information indicated by the card has an information flag appended thereto. As a result of such determination, when it is determined that an information flag is appended, the determination unit 12 determines, as a move destination of the card, the sorting area in which only cards indicating a piece of information with an information flag appended thereto are placed.

<Operation Example>

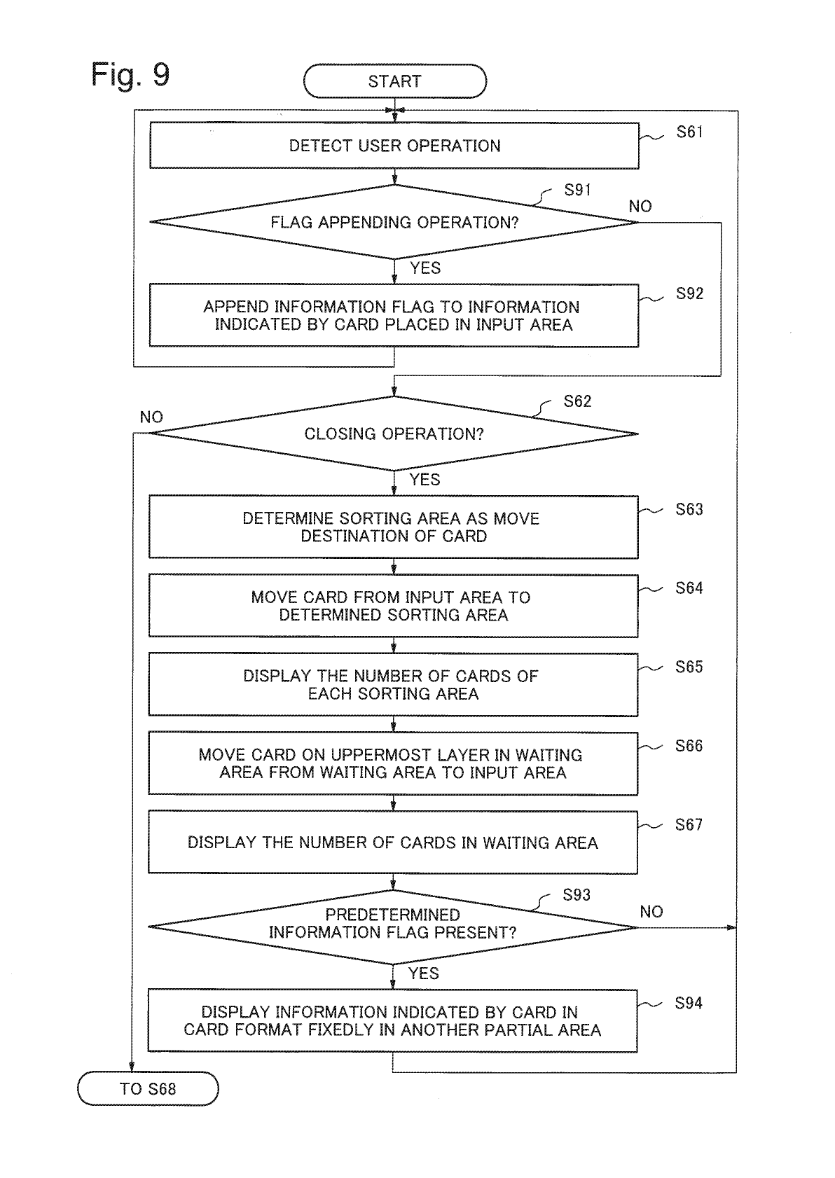

In the following, an information display method according to the second exemplary embodiment will be described with reference to FIG. 9. FIG. 9 is a flow chart showing a part of an operation example of the smart device 10B according to the second exemplary embodiment. In FIG. 9, processing steps with the contents same as those in FIG. 6 are identified by the same signs as those of FIG. 6 and due to limitations of space, illustration of the processing at S68 and the following steps in FIG. 6 is omitted. Although in the following description, it is assumed that each step is executed by the smart device 10B, each step may be executed by a plurality of computers including the smart device 10B. Additionally, since each step has processing contents similar to those of the above-described respective processing units included in the smart device 10B, detailed description of each step will be omitted suitably.

When a flag appending operation is detected (S91; YES), the smart device 10B appends the information flag to the piece of information indicated by a card placed in the input area (S92). When a plurality of kinds of information flags is provided, a kind of information flag to be appended to the information is selected according to the type of flag appending operation.

Subsequently, when a closing operation is detected (S62; YES), the smart device 10B executes the processing of S63 to S67 similarly to the first exemplary embodiment. At this time, when the determination rule for the sorting area includes presence/absence of the information flag, the smart device 10B determines the sorting area as a move destination, by taking into consideration whether the piece of information has an information flag appended thereto or not (S63).

The smart device 10B determines whether the piece of information indicated by a card has a predetermined information flag appended thereto or not (S93). The predetermined information flag that is determined in the processing at S93 is, for example, a reference flag. When determining that the predetermined information flag (e.g., the reference flag) is appended (S93; YES), the smart device 10B displays the piece of information indicated by the card in the processing at S63 in a card format fixedly, in a partial area different from the waiting area, the input area and the subsequent area (S94).

An order of execution of the respective steps included in the information display method according to the second exemplary embodiment is not limited to the order shown in FIG. 9 and can be changed as long as the change does not affect the contents adversely. For example, the processing at S93 and the processing at S94 may be executed prior to the processing of S63 or in parallel with the processing of S63 to S67.

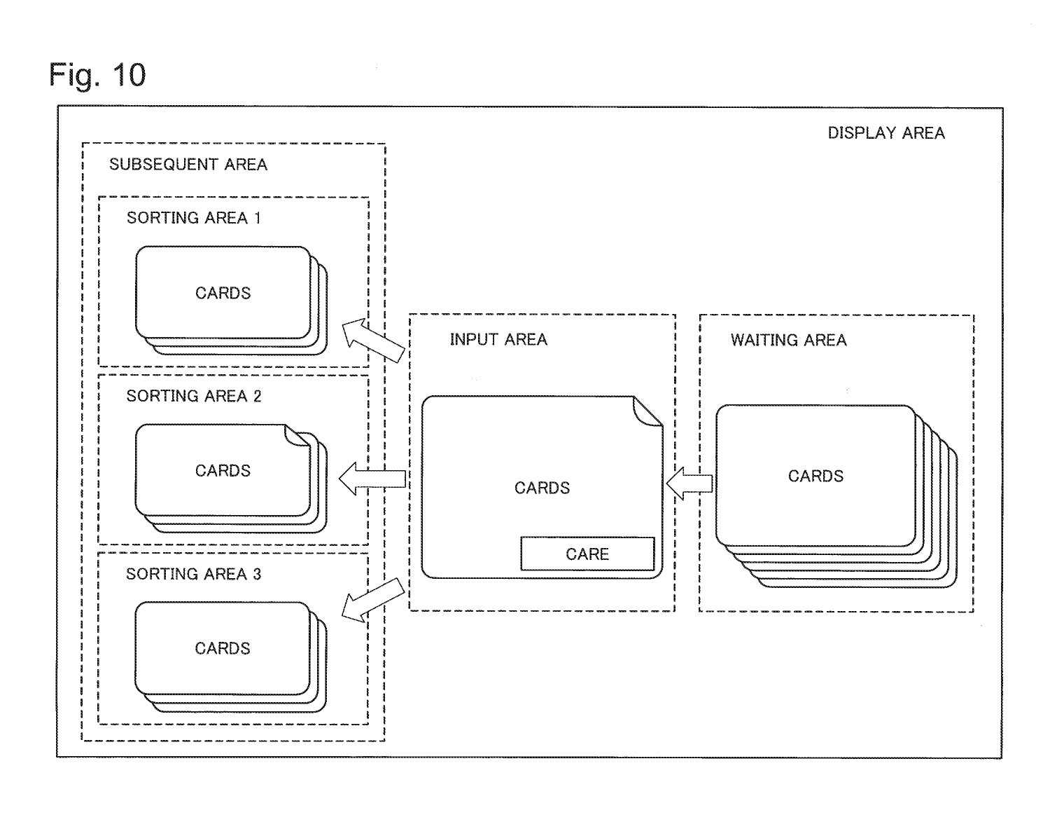

FIG. 10 is a diagram schematically showing a first example of information display according to the second exemplary embodiment. In the example of FIG. 10, on a card placed in the input area, a “care” button is displayed. In this case, the operation of pressing the “care” button is the above-described flag appending operation. When the operation is detected, a “care” flag is appended as the information flag to the piece of information indicated by the card, and a dog-ear is appended to the card indicating the piece of information. In the example in FIG. 10, in the sorting area 2, a card indicating a piece of information to which the “care” flag is appended, is placed.

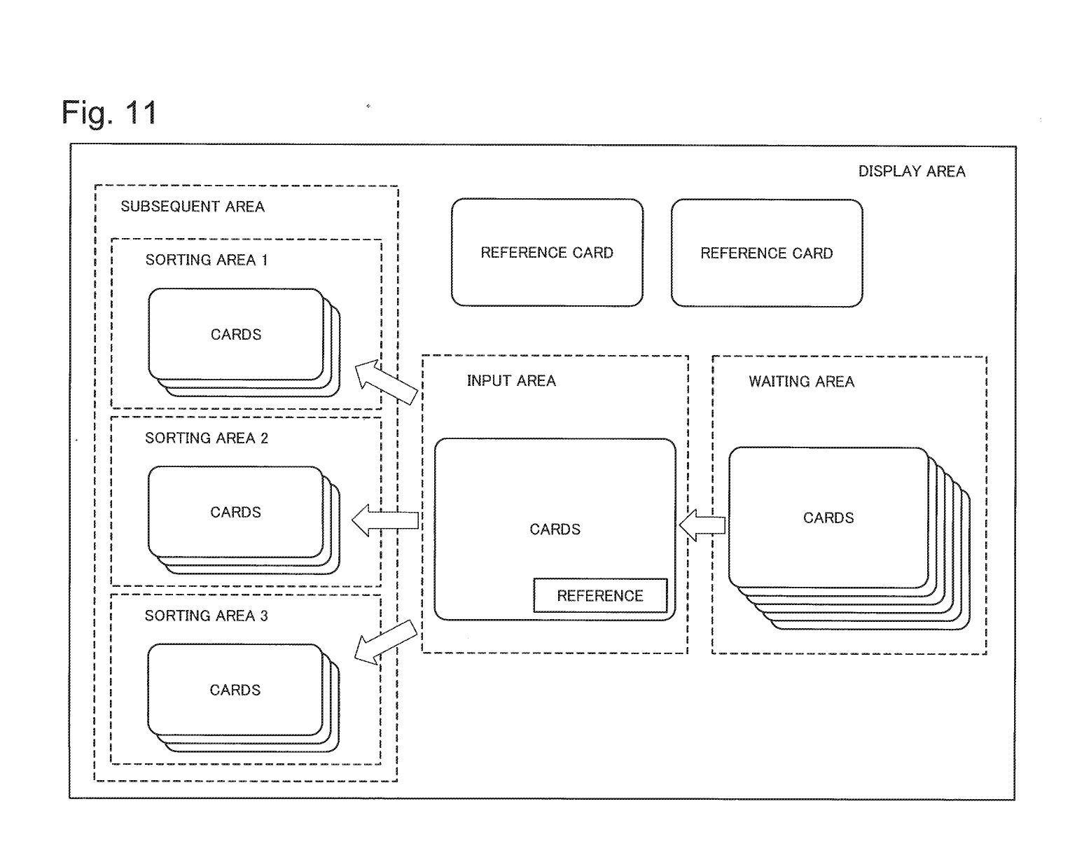

FIG. 11 is a diagram schematically showing a second example of information display according to the second exemplary embodiment. In the example in FIG. 11, on a card placed in the input area, a “reference” button is displayed. In this case, the operation of pressing the “reference” button is the above-described flag appending operation. When the operation is detected, the card is moved from the input area to the subsequent area, and being displayed as a reference card in a partial area arranged above the input area and the waiting area.

### <Functions and Effects of the Second Exemplary Embodiment>

As described above, according to the second exemplary embodiment, in response to a detection of a flag appending operation, an information flag is appended to the piece of information indicated by a card placed in the input area. The display format for the card indicating a piece of information with an information flag appended thereto is changed to a format different from that of other cards. According to the second exemplary embodiment, by looking at the display format of a card, the user can easily understand whether the information flag is appended to the piece of information indicated by the card.

According to the second exemplary embodiment, presence or absence of the information flag can be included in a determination rule for the sorting area. Additionally, according to the second exemplary embodiment, it is possible to provide a sorting area in which only cards indicating a piece of information with the information flag appended thereto are placed. This enables a user to understand easily a piece of information with the information flag appended thereto by referring to cards placed in each sorting area in the subsequent area.

Further, according to the second exemplary embodiment, it is possible to move a card indicating a piece of information with the information flag appended thereto from the input area to the sorting area. It is also possible to display a piece of information with the information flag appended thereto in a card format fixedly in a partial area different from the input area and the subsequent area. Accordingly, by executing the operation of appending the flag to a card indicating a piece of information to be referred to in subsequent work, a user can move the card to the subsequent area, and referring to the piece of information indicated by the card fixedly in the partial area.

### [Modification Examples of the Above-Described Respective Exemplary Embodiments]

A piece of information to be processed in each of the above-described exemplary embodiments, i.e., each piece of information displayed in a card format is stored in the memory 3 by the information processing apparatus and the smart device (10A, 10B). Of all the information to be processed, the information processing apparatus and the smart device (10A, 10B) may store, in the memory 3, only pieces of information to be displayed as a card in the display area or may store all the information in the memory 3. When storing, in the memory 3, only pieces of information to be displayed as a card in the display area, information required is obtained from another computer such as a server apparatus or the like.

The above-described information processing apparatus 100 and the smart device (10A, 10B) can be realized also by a plurality of computers. When a plurality of computers are used for realization, a computer including a device for detecting user operations, such as the touch sensor 5 or the microphone unit 6, may be configured to include only the operation detection unit 11 and the other computers may be configured to include the other processing units. Additionally, a certain computer may include only the operation detection unit 11 and the drawing processing unit 13 while the other computers may include the other processing units.

With respect to the following specific example, each of the above-described exemplary embodiments will be described in more detail. The present invention is not limited to the following specific example.

### [Specific Example]

In the following, description will be made of a case where each of the above-described exemplary embodiments is used for inspection work with respect to a specific example. In this case, each piece of information to be processed is a piece of information for each step of the inspection work or for each item of the inspection.

In the waiting area, cards indicating pieces of information yet to be inspected are displayed as a stack, and in the input area, information of an inspection result such as a measured temperature, a measured meter value or the like, is input into the card. A user executes a closing operation after finishing input of the information of the inspection result to the piece of information indicated by the card placed in the input area. A determination rule for the sorting area includes a determination rule for determining whether the inputted piece of information on the inspection result represent a normal state or not, and according to the determination result, the sorting area as a move destination is determined. By referring to the cards placed in each sorting area, the user can recognize pieces of information determined to be representing a normal state and pieces of information determined to be representing an abnormal state. Further, by referring to the cards displayed in the waiting area, the user can understand a volume of remaining work.

Additionally, a number indicating the order of the inspection work is assigned to the piece of information indicated by each card, and according to the number, the card on the uppermost layer of the card stack in the waiting area is determined. As a result, when input of information of the previous inspection work is completed, a card indicating information on a subsequent inspection work is placed in the input area.

According to the present specific example, by referring to a card placed in the input area, the user can easily understand inspection work to be executed next, without a mistake. Further, when input regarding the current inspection work is completed, input of information about subsequent inspection work is allowed, so that the user can execute the inspection work smoothly in a predetermined appropriate order. This also results in reducing the occurrences of omission of work by the user. Further, by utilizing suspension flags, the user can put aside work to be executed later. By referring to suspension flags, the user can understand the work that has been put aside, even after the time has elapsed.

Further, since each piece of information is displayed in a card format and precise operation is not required as user operation, a user can smoothly execute inspection work while holding the smart device (10A, 10B).

Although in the plurality of flow charts used in the above description, the plurality of steps (processing) are sequentially recited, an execution order of the steps executed in each of the present exemplary embodiments is not limited to the recited order. In each of the present exemplary embodiments, the order of the illustrated steps can be changed as long as the change does not affect the contents adversely. Additionally, the respective exemplary embodiments described above can be combined to the extent that causes no contradiction in contents.

A part or all of the above-described respective exemplary embodiments can also be specified as recited in the following supplemental notes. However, the respective exemplary embodiments are not limited to the following recitation.

(Supplemental Note 1)

An information processing apparatus allows a display unit to display a piece of information as a processing target in a card format, the information including:

an operation detection means for detecting a predetermined operation for a card placed in an input area, among the input area and a subsequent area being arranged in a predetermined direction in a display area, the input area allowing input to the piece of information being indicated by the card;

a determination means, when the operation detection means detects the predetermined operation, on the basis of a state of the piece of information indicated by the card placed in the input area, for determining a sorting area as a move destination of the card from among a plurality of sorting areas provided in the subsequent area; and

a drawing processing means for moving the card placed in the input area to the sorting area determined by the determination unit as the move destination.

(Supplemental Note 2)

The information processing apparatus according to Supplemental Note 1, wherein

the drawing processing means moves the card placed in the input area to the sorting area, and placing a new card indicating another piece of information in the input area.

(Supplemental Note 3)

The information processing apparatus according to Supplemental Note 1 or 2, further including:

a re-sorting means for changing a determination rule for the sorting area, and on the basis of the changed determination rule, reconfiguring the sorting areas arranged in the subsequent area and rearranging the card already placed in the sorting areas into each of the reconfigured sorting areas, wherein

after the determination rule being changed by the re-sorting means, the determination means determines the sorting area as a move destination of the card placed in the input area on the basis of the changed determination rule.

(Supplemental Note 4)

The information processing apparatus according to any one of Supplemental Notes 1 to 3, wherein

a waiting area is arranged at opposite side of the subsequent area so as to be placed in a predetermined direction in the display area, the input area lying therebetween,

the determination means specifies a plurality of pieces of uncompleted information from among the pieces of information displayed in the card format, and

the drawing processing means displays a plurality of the cards placed in each of the plurality of the sorting areas in a stacked form, displays a plurality of the cards each indicating each piece of uncompleted information which has been specified by the determination means in a stacked form in the waiting area, and when moving the card placed in the input area to the sorting area in the subsequent area, moves the card on an uppermost layer of a card stack in the waiting area to the input area as a new card.

(Supplemental Note 5)

The information processing apparatus according to Supplemental Note 4, wherein

a sequence number is assigned to each piece of uncompleted information which has been specified by the determination means, and

the drawing processing means determines the card on the uppermost layer of the card stack in the waiting area on the basis of the sequence number.

(Supplemental Note 6)

The information processing apparatus according to Supplemental Note 4 or 5, further including:

a counter means which obtains a total number of pieces of information displayed in the card format, the number of pieces of uncompleted information and the number of pieces of information indicated by cards placed in each sorting area, wherein

the drawing processing means displays the total number and the number of pieces of uncompleted information in the waiting area and displays, in the subsequent area, the total number and the number in each sorting area.

(Supplemental Note 7)

The information processing apparatus according to any one of Supplemental Notes 4 to 6, wherein

the drawing processing means moves the card placed in one of the plurality of sorting areas to the waiting area.

(Supplemental Note 8)

The information processing apparatus according to any one of Supplemental Notes 1 to 7, further including:

A flag appending means which appends an information flag to a piece of information indicated by the card placed in the input area, wherein

the drawing processing means changes a display format of the card indicating the piece of information to which the information flag is appended, to a display format different from a display format of the card indicating a piece of information to which the information flag is not appended.

(Supplemental Note 9)

The information processing apparatus according to Supplemental Note 8, wherein

the determination means determines whether the information flag is appended to the piece of information indicated by the card placed in the input area, and when the information flag is appended to the piece of information, determines, as a move destination of the card placed in the input area, the sorting area in which only the cards indicating a piece of information to which the information flag is appended are placed.

(Supplemental Note 10)

The information processing apparatus according to Supplemental Note 8 or 9, wherein

the drawing processing means moves the card indicating a piece of information to which the information flag is appended, from the input area to the sorting area, and displaying, in the card format, the piece of information indicated by the card fixedly in a partial area different from the input area and the subsequent area.

(Supplemental Note 11)

An information display method for at least one computer that allows a display unit to display a piece of information as a processing target in a card format, the information display method including:

detecting a predetermined operation for a card placed in an input area, among the input area and a subsequent area being arranged in a predetermined direction in a display area, the input area allowing input to the piece of information being indicated by the card;

when the predetermined operation is detected, on the basis of a state of the piece of information indicated by the card placed in the input area, determining a sorting area as a move destination of the card from among a plurality of sorting areas provided in the subsequent area; and

moving the card placed in the input area to the sorting area determined as the move destination.

(Supplemental Note 12)

The information displaying method according to Supplemental Note 11, further including:

arranging new piece of the card that indicates other information in the input area.

(Supplemental Note 13)

The information displaying method according to Supplemental Note 11 or 12, further including:

changing a determination rule for the sorting area, and on the basis of the changed determination rule, reconfiguring the sorting areas arranged in the subsequent area and rearranging the card already placed in the sorting areas into each of the reconfigured sorting areas, wherein

in the determining of the sorting area as a moving destination of the card, after the determination rule being changed, on the basis of the changed determination rule, the sorting area is determined as a move destination of the card placed in the input area.

(Supplemental Note 14)

The information displaying method according to any one of Supplemental Notes 11 to 13, wherein

a waiting area being arranged at opposite side of the subsequent area so as to be placed in a predetermined direction in the display area, the input area lying therebetween, and the information displaying method further including:

specifying a plurality of pieces of uncompleted information from among the pieces of information displayed in the card format,

displaying a plurality of the cards placed in each of the plurality of the sorting areas in a stacked form,

displaying a plurality of the cards each indicating each piece of uncompleted information which has been specified by the determination means in a stacked form in the waiting area, and

when moving the card placed in the input area to the sorting area in the subsequent area, moving the card on an uppermost layer of a card stack in the waiting area to the input area as a new card.

(Supplemental Note 15)

The information displaying method according to Supplemental Note 14, wherein

a sequence number is assigned to each piece of uncompleted information that has been specified, and the information displaying method further including:

determining the card on the uppermost layer of the card stack in the waiting area on the basis of the sequence number.

(Supplemental Note 16)

The information displaying method according to Supplemental Note 14 or 15, further including:

obtaining a total number of pieces of information displayed in the card format, the number of pieces of uncompleted information and the number of pieces of information indicated by cards placed in each sorting area,

displaying the total number and the number of pieces of uncompleted information in the waiting area, and

displaying, in the subsequent area, the total number and the number in each sorting area.

(Supplemental Note 17)

The information displaying method according to any one of Supplemental Notes 14 to 16 further including:

moving the card placed in one of the plurality of sorting areas to the waiting area.

(Supplemental Note 18)

The information displaying method according to any one of Supplemental Notes 11 to 17, further including:

appending an information flag to a piece of information indicated by the card placed in the input area and

changing a display format of the card indicating the piece of information to which the information flag is appended, to a display format different from a display format of the card indicating a piece of information to which the information flag is not appended.

(Supplemental Note 19)

The information displaying method according to any one of Supplemental Note 18, further including:

determining whether the information flag is appended to the piece of information indicated by the card placed in the input area, wherein

in the determining of the sorting area as a moving destination of the card, when the information flag is appended to the piece of information, the sorting area in which only the cards indicating a piece of information to which the information flag is appended are placed is determined as a move destination of the card placed in the input area.

(Supplemental Note 20)

The information displaying method according to any one of Supplemental Note 18 or 19, further including:

moving the card indicating a piece of information to which the information flag is appended from the input area to the sorting area, and

displaying, in the card format, the piece of information indicated by the card fixedly in a partial area different from the input area and the subsequent area.

(Supplemental Note 21)

A computer program or a computer-readable recoding medium storing the computer program, the computer program causing at least one computer to execute the information display method according to Supplemental Note 11 to Supplemental Note 20.

In the foregoing, the present invention has been described with the above-described exemplary embodiments as model examples. However, the present invention is not limited to the above-described exemplary embodiments. Specifically, various modes that those skilled in the art can appreciate are applicable to the present invention within the scope of the present invention.

The present application claims priority from Japanese Patent Application No. 2014-037799 filed on Feb. 28, 2104, disclosure of which is incorporated herein in its entirety.

### REFERENCE SIGNS LIST

2 CPU
3 memory
4 display unit
5 touch sensor
6 microphone unit
10A, 10B smart device
11, 101 operation detection unit
12, 102 determination unit
13, 103 drawing processing unit
14 re-sorting unit
15 counter unit
16 flag-appending unit
100 information processing apparatus

What is claimed is:

1. An information processing apparatus comprising:
an operation detection unit that is configured to detect, when an input area and a subsequent area are arranged in a predetermined direction in a display area displayed on a display unit, a predetermined operation for a card placed in the input area, the card being able to indicate a piece of information as a processing target in a card format, the input area allowing input to the piece of information that is indicated by the card;
a determination unit that is configured to determine, when the operation detection unit detects the predetermined operation, on the basis of a state of the piece of information indicated by the card placed in the input area, a sorting area as a move destination of the card from among a plurality of sorting areas provided in the subsequent area; and
a drawing processing unit that is configured to move the card placed in the input area to the sorting area determined by the determination unit as the move destination, and allowing the display unit to display the display area and the card.

2. The information processing apparatus according to claim 1, wherein
the drawing processing unit moves the card placed in the input area to the sorting area, and placing a new card indicating another piece of information in the input area.

3. The information processing apparatus according to claim 1, further comprising:
a re-sorting unit that is configured to change a determination rule for the sorting area, and on the basis of the changed determination rule, to reconfigure the sorting areas arranged in the subsequent area and to rearrange the card already placed in the sorting areas into each of the reconfigured sorting areas, wherein
after the determination rule being changed by the re-sorting unit, the determination unit determines the sorting area as a move destination of the card placed in the input area on the basis of the changed determination rule.

4. The information processing apparatus according to claim 1, wherein
a waiting area is arranged at opposite side of the subsequent area so as to be placed in a predetermined direction in the display area, the input area lying therebetween,
the determination unit specifies a plurality of pieces of uncompleted information from among the pieces of information displayed in the card format, and
the drawing processing unit displays a plurality of the cards placed in each of the plurality of the sorting areas in a stacked form, displays a plurality of the cards each indicating each piece of uncompleted information which has been specified by the determination unit in a stacked form in the waiting area, and when moving the card placed in the input area to the sorting area in the subsequent area, moves the card on an uppermost layer of a card stack in the waiting area to the input area as a new card.

5. The information processing apparatus according to claim 4, wherein
a sequence number is assigned to each piece of uncompleted information which has been specified by the determination unit, and
the drawing processing unit determines the card on the uppermost layer of the card stack in the waiting area on the basis of the sequence number.

6. The information processing apparatus according to claim 4, further comprising:
a counter unit that is configured to obtain a total number of pieces of information displayed in the card format, the number of pieces of uncompleted information and the number of pieces of information indicated by cards placed in each sorting area, wherein
the drawing processing unit displays the total number and the number of pieces of uncompleted information in the waiting area and displays, in the subsequent area, the total number and the number of cards in each sorting area.

7. The information processing apparatus according to claim 4, wherein
the drawing processing unit moves the card placed in one of the plurality of sorting areas to the waiting area.

8. The information processing apparatus according to claim 1, further comprising:
A flag appending unit that is configured to append an information flag to a piece of information indicated by the card placed in the input area, wherein
the drawing processing unit changes a display format of the card indicating the piece of information to which the information flag is appended to a display format different from a display format of the card indicating a piece of information to which the information flag is not appended.

9. The information processing apparatus according to claim 8, wherein
the determination unit determines whether the information flag is appended to the piece of information indicated by the card placed in the input area, and when the information flag is appended to the piece of information, determines, as a move destination of the card placed in the input area, the sorting area in which only the cards indicating a piece of information to which an information flag is appended are placed.

10. The information processing apparatus according to claim 8, wherein
the drawing processing unit moves the card indicating a piece of information to which the information flag is appended from the input area to the sorting area, and displays, in the card format, the piece of information indicated by the card fixedly in a partial area different being from the input area and the subsequent area.

11. An information display method executed by at least one computer, the information display method comprising:
when an input area and a subsequent area are arranged in a predetermined direction in a display area displayed in a display unit, detecting a predetermined operation for the card placed in the input area, the card being able to indicate a piece of information as a processing target in a card format, the input area allowing input to the piece of information that is indicated by the card;
when the predetermined operation is detected, on the basis of a state of the piece of information indicated by the card placed in the input area, determining a sorting area as a move destination of the card from among a plurality of sorting areas provided in the subsequent area;
moving the card placed in the input area to the sorting area determined as the move destination; and
displaying, by the display unit, the display area and the card.

12. A non-transitory computer readable recording medium storing a program that causes at least one computer to execute processing of:
when an input area and a subsequent area are arranged in a predetermined direction in a display area displayed in a display unit, detecting a predetermined operation for the card placed in the input area, the card being able to indicate a piece of information as a processing target in a card format, the input area allowing input to the piece of information that is indicated by the card;
when the predetermined operation is detected, on the basis of a state of the piece of information indicated by the card placed in the input area, determining a sorting area as a move destination of the card from among a plurality of sorting areas provided in the subsequent area;
moving the card placed in the input area to the sorting area determined as the move destination; and
displaying, by the display unit, the display area and the card.
